(19) United States
(12) Patent Application Publication
(10) Pub. No.: US 2010/0253504 A1
(43) Pub. Date: Oct. 7, 2010

(54) METHOD FOR WIRELESSLY MONITORING THE PRESENCE OR ABSENCE OF ONE OR MORE PERSONS AND ASSOCIATED PERSON MONITORING SYSTEM

(76) Inventors: Anthony J. Lliteras, Margate, FL (US); Carl J. Regan, JR., Palm Springs, FL (US); William J. Weiss, Boca Raton, FL (US)

Correspondence Address: GRAYROBINSON, P.A., SUITE 1850, 401 EAST LAS OLAS BLVD., FORT LAUDERDALE, FL, 33301, US

(21) Appl. No.: 12/418,346

(22) Filed: Apr. 3, 2009

(51) Int. Cl. G08B 1/08

(52) U.S. Cl. 340/539.11; 340/573.4

(57) ABSTRACT

A person monitoring system employs an exemplary method for wirelessly monitoring one or more persons, wherein each person is initially positioned in a respective person support device (PSD) and each PSD is associated with a presence determining device (PDD) operable to detect a presence of a person in the PSD. A portable unit (PU) of the system wirelessly receives status signals during a training period from one or more PDDs. Each status signal includes a respective identifier corresponding to the PDD. The PU stores identifiers included in status signals received during the training period to produce monitored identifiers. After expiration of the training period, the PU wirelessly receives status signals from at least some of the PDDs. The PU then determines whether each monitored identifier is included in at least one respective post-training status signal received during a predetermined time interval and, if not, alerts a user of the PU.

### BACKGROUND OF THE INVENTION

1. Field of the Invention

The present invention relates generally to systems for monitoring the presence or absence of a person or an object from a location and, more particularly, to a method and system for wirelessly monitoring the presence or absence of persons in or from support devices, such as car seats, beds, or wheelchairs, and alerting parents or caregivers when one or more monitored persons and a caregiver are undesirably separated.

2. Description of Related Art

Car and booster seats are commonly used for safely restraining children when the children are passengers in motor vehicles. Because of the increased safety they provide, car and booster seat use is now mandated in most, if not all, of the United States. As a result of the proper use of car and booster seats, injuries to children involved in automobile accidents have decreased over the years.

On occasion, however, use of a car seat can result in another type of injury to children. With their child restrained in a car or booster seat in the back seat of the car, and with parents busier and more preoccupied than ever, even the most attentive parents could accidentally leave their vehicle while their sleeping child remains in the car or booster seat. The unintentionally abandoned child is then subject to injury from choking, asphyxiation, hypothermia, dehydration, and other disastrous effects. In fact, there have been a disturbingly large number of cases over the last few years of children dying after being accidentally left unattended for too long in their parent's vehicles. By one estimate, more than 600 children died since 2000 because they were left in cars unattended.

Another catastrophe associated with children and distracted parents is child abduction. Children have been taken from their parents or caregivers at theme parks, shopping malls and other locations even though the children were in strollers or other carriers controlled by their parents. Child abductors often work in teams. When taking a child, one or more of the abductors cause a disturbance that distracts the parent and another one of the abductors takes the child. Alternatively, abductors stalk a child and wait for the opportune time to take the child when a parent moves away from the child carrier. The chances of successfully retrieving a missing or stolen child decreases rapidly with time. As a result, rapid notification that a child has been taken is critical to increasing the chances of successfully retrieving the child and bringing the abductor to justice.

A variety of systems for monitoring the presence of a child or object at a location are known. Exemplary systems are disclosed in U.S. Pat. No. 5,095,430 to Flanagan et al. (“the '430 Patent”) and U.S. Pat. No. 7,106,203 to Edwards et al. (“the '203 Patent”). The '430 Patent describes an object-proximity monitoring and alarm system for use with an object carrier, such as a car seat. The system includes a weight-sensitive mat or other presence sensor, a transmitter, a receiver and an alarm. The receiver and the alarm are incorporated into a portable unit. According to the '430 Patent, the presence sensor determines whether the child seat is occupied. The transmitter indicates to the portable unit receiver that the child seat is occupied, as determined by the sensor. If the portable unit is removed from a proximity of the transmitter at a time during which the sensor detects that the seat is occupied, the portable unit alarm is activated to alert the user to retrieve the child.

The '203 Patent describes a self-activating system for alerting someone that an object or person has been left unattended, as is the case when a child is left restrained or unattended in a car seat. The disclosed system includes a detector for sensing the presence and/or absence of a child in a car seat, a transmitter for automatically transmitting wireless signals, and a portable receiving unit. The wireless signals transmitted by the transmitter include a first signal when the child is in the car seat and a second signal when the child is removed from the car seat. The portable unit includes a receiver that is capable of receiving the wireless signals. A parent or other responsible caregiver, who is typically the driver of the vehicle in which the car seat is located, possesses the portable unit.

The portable unit of the '203 Patent is programmed to carry out at least two timing functions. A first timing function is enabled when the first signal is initially sensed indicating that the child is in the car seat. Once enabled, the first timing function times to a first interval or intervening period of time. At the completion of each first interval, the portable unit can implement a variety of actions. Specifically, the portable unit can (i) continue the first timing function if the first signal is sensed indicating that the portable unit receiver is still in proximity to the child in the car seat; (ii) disable the first timing function if the second signal is sensed indicating that the child has been removed from the car seat; or (iii) enable the second timing function if neither the first signal nor the second signal is sensed. The start of the second timing function indicates that the responsible caregiver, who is presumed to still be in possession of the portable unit, has ventured outside the range of the transmitter while the child remains located in the car seat. If enabled, the second timing function times to a second interval having a first time and a later second time. The portable unit issues a first alarm signal at the first time if neither the first signal nor the second signal is sensed. However, the portable unit discontinues the first alarm signal if the first signal is sensed during the second interval indicating that the caregiver possessing the portable unit has returned within the range of the transmitter while the child is still located in the car seat. The portable unit issues a second alarm signal if the first signal is not sensed during the second interval. The second alarm signal is allowed to continue after the second time until the second signal is sensed. That is, the second alarm signal continues until the caregiver possessing the portable unit has returned to the vicinity of the transmitter and the child has been removed from the car seat.

While the '430 Patent and the '203 Patent provide techniques for wirelessly monitoring whether a child has been unintentionally left in a carrier, such as a car seat, neither patent addresses mitigating child abductions. For example, the '203 Patent describes transmission of a second signal when the child seat is empty, which signal serves to prevent the portable unit from alarming because the portable unit thinks the car seat has been safely vacated. Additionally, neither patent addresses how the portable unit can be simultaneously used with multiple presence sensors, as may be necessary to monitor the presence of multiple children in a car, in strollers, or elsewhere.

To mitigate the chances of child abduction or other undesired separation of a child from his or her parents, devices such as child leashes and child proximity monitors are also known for monitoring the whereabouts of children. A child leash includes a harness that is secured to the child and a leash or strap that connects to the harness and is held by the parent or caregiver. Child monitoring devices generally include a wireless transmitter and a portable receiving unit. The transmitter is secured to the child (e.g., around the child's neck) by a hanging rope or chain. The parent or guardian holds the portable unit, which receives wireless signals transmitted by the transmitter. When the receiver stops receiving the transmitted signals, an alarm in the receiving device alerts the parent or guardian that the child has wandered away. While child leashes and monitoring devices provide some level of security, they are fairly obtrusive and provide no protection if removed from the child. Also, existing wireless child monitoring devices do not facilitate use of a single portable receiving unit with multiple transmitting units.

In view of the foregoing, a need exists for a person monitoring system and method that are capable of contemporaneously monitoring for abductions of persons from multiple carriers or other support devices, such as beds or playpens, as well as contemporaneously monitoring for the unintended leaving of persons in such support devices when a parent or guardian roams away from the support devices.

### BRIEF DESCRIPTION OF THE DRAWINGS

The accompanying figures, wherein like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a system for wirelessly monitoring the presence or absence of a person or object in accordance with an exemplary embodiment of the present invention.

FIG. 2 is a top view and block diagram of the system of FIG. 1 in accordance with an exemplary mat-type embodiment of the present invention.

FIG. 3 is a cross-sectional view of a motor vehicle incorporating a presence determining device of the system of FIG. 1 in accordance with an exemplary embodiment of the present invention.

FIG. 4 is a flow diagram of a method for wirelessly monitoring a presence or absence of one or more persons in or from associated person support devices in accordance with an exemplary embodiment of the present invention.

FIG. 5 is a flow diagram of a method for automatically detecting unauthorized removal of a person from a person support device in accordance with an alternative embodiment of the present invention.

### DETAILED DESCRIPTION

Before describing in detail exemplary embodiments that are in accordance with the present invention, it should be observed that the embodiments reside primarily in combinations of apparatus components related to implementing a method and apparatus for wirelessly monitoring the presence or absence of a person. Accordingly, various apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element. Additionally, the term “person support device,” as used herein and in the appended claims, refers to any device on which a person may lie, sit or stand and that supports at least a portion of the person. Exemplary “person support devices” include, but are not limited to, seats (including, without limitation, child car seats, booster seats, and automobile seats), chairs, strollers, wheelchairs, playpens, baby swings, baby bouncers, child carriers, shopping carts, beds, cribs, bassinets, blankets, rugs, and any other device or object in or on which a person may lay or sit.

Generally, the present invention encompasses a method and system for wirelessly monitoring the presence or absence of a person, such as a child, from a person support device, such as a car seat, playpen, or bed. According to one exemplary embodiment, the system includes one or more presence determining devices and a portable unit. Each presence determining device is installable in a person support device and includes one or more sensors, a controller, and a transmitter.

The sensor(s) sense or detect one or more parameters indicative of whether a person is present within the person support device in which the presence determining device is installed. For example, the sensors may include an organized set of weight or pressure sensors (e.g., an array of pressure sensors) that detects weight or pressure when a person is placed upon the presence determining device. Detection of the exemplary parameter of pressure or weight upon the pressure sensors would provide an indication that a person was present upon the presence determining device and within the person support device in which the presence determining device is installed. By contrast, failure to detect pressure or weight upon the pressure sensors would provide an indication that a person was not present upon the presence determining device or within the person support device in which the presence determining device is installed. Additionally or alternatively, if the presence determining device includes one or more strap and buckle arrangements, the sensors may include one or more magnetic or other switches configured to detect whether a buckle has been fastened or unfastened (e.g., inserted or removed from a corresponding clasp). Detection that the buckle is fastened (e.g., insertion of the buckle into its clasp) would provide an indication that a person was present within the person support device in which the presence determining device is installed. By contrast, detection that the buckle is unfastened (e.g., not inserted in or has been removed from the clasp) would provide an indication that a person was not present within or had been removed from the person support device in which the presence determining device is installed. In an alternative embodiment, each pressure determining device may itself be the person support device or may be integrated into the person support device (e.g., form part of a car seat integrated into a motor vehicle).

The controller of each presence determining device is coupled to the sensor(s) and is operable to generate a status signal responsive to the sensor(s) sensing one or more parameters indicative that a person is present within the person support device in which the presence determining device is installed. The status signal includes an identifier associated with the presence determining device. In one embodiment, an identifier may be pre-stored in a memory (which may be separate from or integrated into the controller) of each presence determining device. Alternatively, where the system includes multiple presence determining devices (e.g., for use with multiple child car seats and/or booster seats), the identifier may be a combination of a pre-stored identification and a manually set identifier, such as the combination of a pre-stored serial number and a number or value manually set through manipulation of a dual in-line package (DIP) switch. The transmitter is coupled to the controller and operable to wirelessly and repeatedly (e.g., periodically or aperiodically) transmit the status signal supplied by the controller.

The portable unit, which may be a key fob or other portable device, includes a receiver, a processor, and an alarm mechanism. The receiver is operable to receive status signals transmitted by the transmitter of the presence determining device when the receiver is within range of the transmitter and the portable unit is powered on. The processor is coupled to the receiver and is operable to perform several functions. First, the processor is operable to determine an identifier included in each status signal received during a training or reference period commencing after the portable unit has been powered on (e.g., for approximately 30 seconds after the portable unit has been powered on). The training period allows the processor to determine how many presence determining devices (and persons) there are to monitor. The identifiers received during the training period are then monitored after expiration of the training period. Status signals received after expiration of the training period which do not include identifiers being monitored are preferably ignored from a monitoring perspective, although they may still be received for other purposes (e.g., diagnostics, historic reporting, and/or status reporting).

The portable unit's processor is also operable to determine an alarm condition responsive to failure of the receiver to receive a status signal that includes a monitored identifier within predetermined time intervals commencing after expiration of the training period. In one embodiment, the processor expects to receive at least one status signal containing a monitored identifier every three seconds. If the processor fails to receive a status signal containing a particular monitored identifier within the predetermined interval, the processor instructs the alarm mechanism to issue an alarm to the caregiver or other user of the portable device. The alarm may be audible, visible, and/or tactile. Thus, according to one embodiment of the present invention, lack of a timely received status signal from one of the monitored presence determining devices causes the portable unit to activate an alarm notifying the user. Depending on the particular circumstances, the alarm may indicate that the person has been left unintentionally in the person support device or that the person has been removed (e.g., abducted) from the person support device without authorization.

As one of ordinary skill in the art will readily appreciate, the present invention may also be used to monitor the presence or absence of objects, such as, for example, laptop computers and purses, from object support devices, such as seats, chairs, desk tops, table tops, and so forth. Additionally, a system in accordance with the present invention may be a kit that is used with various person support devices or may include one or more person support devices, such as when the presence determining devices are integrated into the person support devices. Further, a system in accordance with the present invention may form part of a motor vehicle that includes a cabin or other compartment containing seats in or on which one or more presence determining devices are installed.

By monitoring the presence or absence of persons or objects in such a manner, the present invention enables multiple persons or objects to be individually monitored with a single portable unit. Prior art car seat monitoring devices do not contemplate use of multiple presence determining devices with a single portable unit and, therefore, do not describe a protocol for handling multi-person monitoring through a single portable unit. Additionally, the present invention facilitates monitoring for abduction or theft of a monitored person or object by, for example, providing for the transmission of status signals only when a person or object is determined to be present in a support device. Prior art car seat monitoring systems do not account for abduction and instead focus primarily on monitoring for whether a parent or other caregiver may have unintentionally left a child or object in a car.

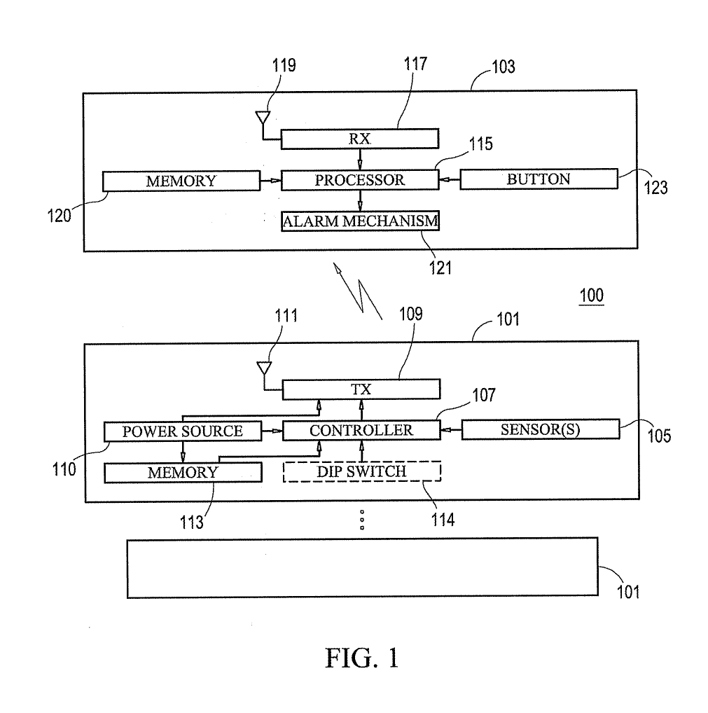

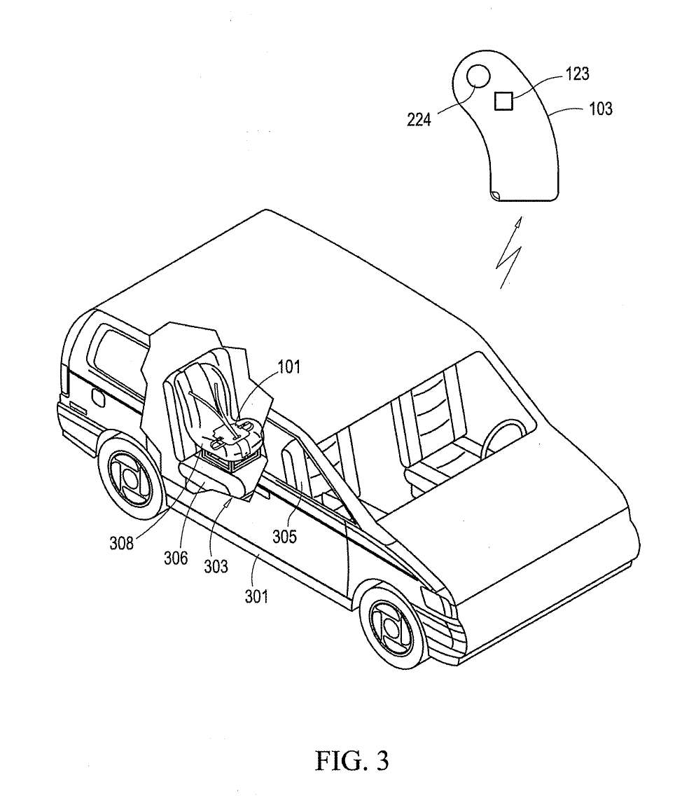

The present invention can be more readily understood with reference to FIGS. 1-5, in which like reference numerals designate like items. FIG. 1 is a block diagram of a system 100 for wirelessly monitoring the presence or absence of a person in accordance with an exemplary embodiment of the present invention. The system 100 includes one or more presence determining devices 101 (two shown) and a portable unit 103. The portable unit 103 may be a key fob or any other device configured to be carried by a user of the system 100. Each presence determining device 101 is preferably adapted for installation in a person support device, such as an automobile seat, an integrated car seat, an after-market car seat, a stroller, a shopping cart, a bed, a playpen or any other device or object in or on which a person (e.g., a child) may lay or sit. As a result, the system 100 may also include the person support device (e.g., as illustrated on an exemplary basis in FIG. 3). The installation of a presence determining device 101 in a person support device may be temporary, such as placing the presence determining device 101 on a car seat just before the person sits on it, or may be permanent, such as by integrating the presence determining device 101 into an automobile seat or after-market car seat during manufacture of the seat.

Each presence determining device includes, inter alia, at least one sensor 105, a controller 107, a transmitter 109 (denoted “TX” in FIG. 1), a power source 110 (e.g., one or more batteries), an antenna 111, and a memory 113. Although illustrated separately, one of ordinary skill in the art will readily recognize and appreciate that the antenna 111 and the transmitter 109 may be integrated into a single integrated circuit. The presence determining device 101 may optionally include a dual inline package (DIP) switch 114 or other appropriate device to enable the user (e.g., parent, guardian, or other caregiver) to at least partially set the value of an identifier (ID) for the presence determining device 101, as discussed in more detail below.

The sensor or sensors 105 are operable to sense one or more parameters indicative of whether a person is present within a person supporting device in which the presence determining device is installed. For example, the sensor 105 may be a weight or pressure sensor operable to sense or detect weight-induced pressure when a person stands, sits, or lays on a housing containing the sensor 105. The sensing of pressure or weight would be indicative that a person was present in the person support device in which the presence determining device 101 is installed. Alternatively or additionally, the sensor 105 may be a magnetic or electrical switch that detects when a strap and buckle arrangement or other fastening mechanism is used to secure a person to the presence determining device 101 or to secure the presence determining device 101 to the person support device in which it is installed. When the presence determining device 101 is integrated into a person support device, such as a child car seat or an automobile seat, the magnetic or electrical switch sensor 105 may detect when a seat belt or other fastening mechanism is used to retain a person in the person support device in which the presence determining device 101 is installed. The sensing of fastening of the buckle would be indicative that a person has been secured to the presence determining device 101 (or within the person support device, as applicable) and, therefore, is present within the person support device in which the presence determining device 101 is installed. In yet another embodiment, multiple sensors 105 may be employed (e.g., a weight sensor and a buckle sensor).

The transmitter 109 may be any low power transmitter preferably providing, in combination with the antenna 111, omni-directional coverage of approximately six (6) to approximately sixteen (16) meters (approximately twenty (20) to approximately fifty (50) feet) from a location of the presence determining device 101. The transmitter 109 includes various components, such as upconverters, filters and amplifiers, as is known in the art. In one embodiment, the transmitter 109 may operate over unlicensed frequency spectrum, such as in the 315 Megahertz (MHz) or 433.92 MHz frequency range. For example, the transmitter 109 may be implemented as a model AM-RT4-315 transmitter module, which is commercially available from RF Solutions Ltd. of East Sussex, United Kingdom.

The controller 107 may be a microprocessor, a microcontroller, a digital signal processor (DSP), a state machine, logic circuitry, or any other device or combination of devices that processes information based on operational or programming instructions stored in the memory 113. One of ordinary skill in the art will recognize that when the controller 107 has one or more of its functions performed by a state machine or logic circuitry, the memory containing the corresponding operational instructions can be embedded within the state machine or logic circuitry as opposed to being external to the controller 107. In one embodiment, the controller 107 may be implemented as a model PIC16F688 microcontroller, which is commercially available from Microchip Technology, Inc. of Chandler, Ariz.

In one embodiment, the memory 113 stores, inter alia, an identification, such as a serial number or other hardware identifier for its presence determining device 101, as well as one or more applications (not shown) executed by the controller 107 during operation of the presence determining device 101. The memory 113, which may be a separate element as depicted in FIG. 1 or may be integrated into the controller 107, can include random access memory (RAM), read-only memory (ROM), FLASH memory, electrically erasable programmable read-only memory (EEPROM), removable memory, and/or various other forms of memory as are well known in the art. It will be appreciated by one of ordinary skill in the art that the various memory components can each be a group of separately located memory areas in the overall or aggregate device memory and that the device memory may include one or more individual memory elements.

The power source 110 preferably comprises a battery or series of batteries (e.g., a set of Lithium ion batteries) providing sufficient power to meet the energy needs of the controller 107, the transmitter 109, the memory 113, and any other components of the presence determining device 101 that require direct current (DC) power to function. Alternatively, the power source 110 may be any other device that supplies DC power to the controller 107, the transmitter 109, and the memory 113.

The optional DIP switch 114 preferably includes four or more slide or toggle switches, thereby providing over 32,000 different possible identifiers for the presence determining devices 101 when the identifier for each presence determining device 101 is produced by combining a 13-bit hard-coded serial number stored in the memory 113 with 4-bits manually selectable by the user through the DIP switch 114. The DIP switch 114 allows the system user to set a different identifier for each of multiple (up to four in this case) presence determining devices 101 that may be used contemporaneously to detect the presence of multiple persons. For example, if a parent is using the system 100 to monitor three children, the parent can set three different DIP switch settings for the three devices, thereby providing three different identifiers for the three presence determining devices 101, even assuming that the hard-coded serial numbers of the three presence determining devices 101 are the same (which would be very unlikely). One of ordinary skill in the art would readily appreciate that higher order DIP switches (i.e., those capable of setting more than 4 bits) can be used where the portable unit 103 may be contemporaneously monitoring more than four presence determining devices 101. One of ordinary skill in the art would also appreciate that a larger range of serial numbers or other identifiers (e.g., 16-bit serial numbers) may be utilized instead of allowing manual setting of some of the bits by the user through a DIP switch 114 or other equivalent device. The goal of the identifier established by the hard-coded serial number alone or in combination with the DIP switch 114 is to substantially mitigate the likelihood that any two or more presence determining devices 101 within a reception range of the portable unit 103 have the same identifiers, which would prevent the portable unit 103 from distinguishing between the two presence determining devices 101.

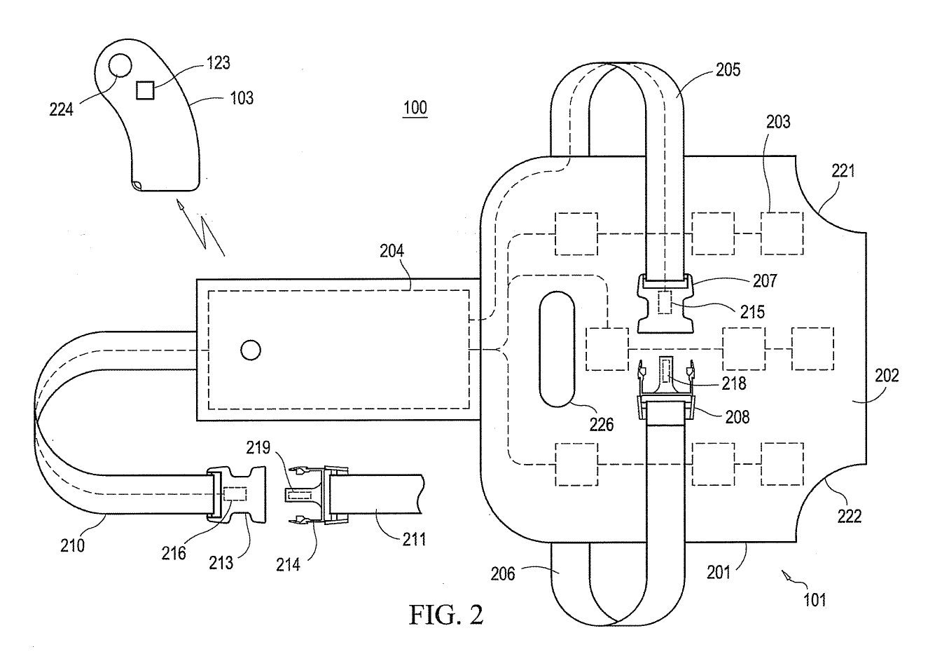

The portable unit 103 is generally configured to be carried by a user and includes, inter alia, a processor 115, a receiver 117 (denoted “RX” in FIG. 1), an antenna 119, memory 120, an alarm mechanism 121, and an optional user interface (e.g., a button 123). Although not expressly shown in FIG. 2, one of ordinary skill in the art will appreciate that the portable unit 103 also includes a DC power source, such as a battery or a series of batteries, for supplying power to the processor 115, the receiver 117, the memory 120, the alarm mechanism 121, and any other components of the portable unit 103 that require DC power to function. The processor 115 may be a microprocessor, a microcontroller, a DSP, a state machine, logic circuitry, or any other device or combination of devices that processes information based on operational or programming instructions stored in memory (not shown). One of ordinary skill in the art will recognize that when the processor 115 has one or more of its functions performed by a state machine or logic circuitry, the memory containing the corresponding operational instructions can be embedded within the state machine or logic circuitry as opposed to being external to the processor 115. In one embodiment, the processor 115 may be implemented as a model PIC16F688 microcontroller, which is commercially available from Microchip Technology, Inc. of Chandler, Ariz.

The receiver 117 may be any low power receiver preferably providing, in combination with the antenna 119 and the transmitter 109 and antenna 111 of the presence determining device 101, omni-directional coverage of approximately six (6) to approximately sixteen (16) meters (approximately twenty (20) to approximately fifty (50) feet) from a location of the presence determining device 101. The receiver 117 includes various components, such as down-converters and filters, as is known in the art. In one embodiment, the receiver 117 may operate over unlicensed frequency spectrum, such as in the 315 MHz or 433.92 MHz frequency range. Those of skill in the art will readily appreciate that the receiver 117 and the transmitter 109 form a complementary pair that facilitates wireless communication from the presence determining device 101 to the portable unit 103. In one embodiment, the receiver 117 may be implemented as a model AM-HRR8-315 receiver module, which is commercially available from RF Solutions Ltd. of East Sussex, United Kingdom.

The memory 120, which may be a separate element as depicted in FIG. 1 or may be integrated into the processor 115, can include RAM, ROM, FLASH memory, EEPROM, removable memory, and/or various other forms of memory as are well known in the art. It will be appreciated by one of ordinary skill in the art that the various memory components can each be a group of separately located memory areas in the overall or aggregate device memory and that the device memory may include one or more individual memory elements.

The alarm mechanism 121 is responsive to the processor 115 to alert the person holding or otherwise carrying the portable unit 103 as to an alarm condition, which may be one of several possible alarm conditions. The alarm mechanism 121 may include one or more of a visual alerting device (e.g., one or more light emitting diodes (LEDs) and associated drive circuitry), an audible alerting device (e.g., a speaker or transducer and associated drive circuitry), and a tactile alerting device (e.g., a vibrating transducer and associated driver circuitry).

The optional user interface may be a button 123 or any other device (e.g., a touchpad, a keypad, or a microphone (e.g., where the processor 115 is voice-activatable)) that allows the user to interact with the processor 115 to, for example, power the portable unit on or off or temporarily deactivate the alarm mechanism 121, as discussed in more detail below.

In operation, each presence determining device 101 used in the system 100 is configured to be installed in a respective person support device (e.g., a child support device). In one embodiment, when multiple children or other persons are to be monitored and each presence determining device 101 includes a manually settable DIP switch 114, the user sets the DIP switch 114 of each presence determining device 101 to a different setting prior to or after installing each presence determining device 101 in its respective person support device, but prior to powering on the portable unit 103. As noted above, setting the DIP switch 114 to a different setting for each presence determining device 101 insures that the identifier for each presence determining device 101 is unique vis-à-vis one another. Also, the combination of the DIP switch setting together with the hard-coded serial number stored in the memory 113 of the presence determining device 101 renders operation of two commonly identified presence determining devices 101 within range of the portable unit 103 highly unlikely.

After each presence determining device 101 has been installed and, if necessary, had its identifier manually set, the user of the system 100 (e.g., a parent, guardian, or other caregiver) places a person (e.g., child) into a person support device in which a presence determining device 101 is installed. In one embodiment, the presence determining device 101 is placed in the person support device such that at least a portion of the person placed in the person support device presses against the presence determining device 101 under the weight of the person. Alternatively or additionally, the presence determining device 101 may include a strap and buckle arrangement that, when fastened, secures the person to the presence determining device 101 and/or in the person support device. In one embodiment, the presence determining device 101 is preferably automatically activated in that the transmitter 109 is turned on and the controller 107 generates status signals only upon the sensors' detecting a weight of the person on the presence determining device 101 and/or upon detecting fastening of the buckle in a strap and buckle arrangement. Thus, in this embodiment, the presence determining device 101 is self-activated and does not have a separate on/off or power switch. Alternatively, the presence determining device 101 may have a separate power switch that would be activatable by a user when monitoring of the presence determining device 101 was desired.

Once activated, the controller 107 of the presence determining device 101 supplies a status signal to the transmitter 109 on a repeated basis (e.g., periodically every half a second or at such other times as may be desired to achieve presence determining functionality generally in accordance with the present invention). The status signal includes at least the identifier of the presence determining device 101, which, as discussed above, is preferably the combination of a hard-coded serial number or other identification number and a DIP switch setting. The controller 107 encodes the identifier in accordance with known encoding techniques and applies a predetermined modulation to the encoded signal to create the status signal. In one embodiment, the controller 107 modulates the encoded identifier using amplitude modulation to produce the status signal and provides the status signal to the transmitter 109. The transmitter 109, when activated, wirelessly transmits the status signal via the antenna 111 for reception by any compatible receiver 117 within the transmission range of the presence determining device 101. The transmission range of the presence determining device 101 may be determined by the effective radiated power level of the transmitter 109 in combination with the transmit antenna 111 and the sensitivity of the receiver 117 in combination with the receive antenna 119, as is known in the art. In one embodiment, the system 100 is designed such that the transmission range of the presence determining device 101 is approximately nine (9) meters (approximately 30 feet).

After installing each presence determining device 101 and placing a child in one or more of the person support devices in which a presence determining device 101 is installed (or placing a child in one or more person support devices in which a presence determining device 101 has been pre-installed or integrated into the person support device), the system user activates the portable unit 103 by, for example, pressing the button 123. Upon power up, the portable unit processor 115 may optionally supply a drive signal to the alarm mechanism 121 or a portion thereof (e.g., an LED) to notify the user that the portable unit 103 is powered on and has entered a training period or mode. During the training period, the portable unit receiver 117 receives status signals from one or more presence determining devices 101 and the processor 115 determines the identifiers contained in the received status signals. The processor 115 stores the identifiers from status signals received during the training period in the portable unit memory 120. The training period allows the portable unit 103 to determine how many presence determining devices 101 to monitor and to store the identifiers of the to-be-monitored presence determining devices 101 in memory 120. In one embodiment, the training period may last approximately ten (10) seconds, although other lengths of time may be used. Additionally, in one embodiment, the controller 107 of each activated presence determining device 101 is programmed to transmit a status signal every three hundred (300) milliseconds so that the portable unit processor 115 receives a status signal at least once within a predetermined time interval, such as every two (2) to five (5) seconds (e.g., every three (3) seconds). As those of ordinary skill in the art will readily recognize and appreciate, alternative time durations and intervals for the training period and for transmission of the status signal, respectively, may be chosen depending upon system configuration.

After expiration of the training period, the portable unit 103 continues to receive status signals from presence determining devices 101 within the portable unit's coverage range. The portable unit processor 115 extracts the identifier contained in each status signal and compares the identifier to the list of monitored identifiers stored in memory 120. If the received identifier does not match one of the monitored identifiers, the portable unit processor 115 ignores the status signal. On the other hand, if the received identifier matches one of the monitored identifiers, the processor 115 processes the status signal. If the user desires to change which presence determining devices 101 are being monitored, the user need merely power cycle the portable unit 103, which restarts the training period and causes the portable unit processor 115 to search for status signals from the presence determining devices 101 to be monitored during the new monitoring session.

Besides including an identifier, each status signal may optionally include other status information, such as a battery level indicator, a sensor status indicator for one or more sensors 105 in the presence determining device 101 that transmitted the status signal, and/or a seat identifier indicating a location within a vehicle of the seat upon which the presence determining device 101 is installed. Thus, depending on the content of the status signal, the portable unit processor 115 may instruct the alarm mechanism 121 to issue an alarm to the user of the portable unit 103. For example, if a status signal received from a monitored presence determining device 101 further includes an indication that a sensor (e.g., a buckle sensor in a buckle of a strap and buckle arrangement) has detected an event or alarm condition (e.g., the unfastening of the buckle), the portable unit processor 115 may instruct the alarm mechanism 121 to notify the user of the alarm condition through use of a visual, audible, and/or tactile alert. Alternatively, if the status signal from a monitored presence determining device 101 further includes an indication that the battery level of the presence determining device's power source 110 is undesirably low (e.g., below a predetermined threshold as determined by the presence determining device's controller 107), the portable unit processor 115 may instruct the alarm mechanism 121 to notify the user of such condition through use of a visual, audible, and/or tactile alert. The alarms for the various possible events or alarm conditions preferably vary to enable the user to readily discern which event is being indicated by the portable unit 103. Additionally, in one embodiment, if multiple alarm conditions are detected as a result of monitoring multiple presence determining devices, the portable unit processor 115 may be programmed to alarm the user with the highest level alert corresponding to the most severe of the detected alarm conditions.

In one embodiment, the most serious alarm condition occurs when the portable unit processor 115 fails to receive a status signal from a monitored presence determining device 101 within the predetermined time interval (e.g., every three (3) seconds). Failure of the portable unit processor 115 to receive a status signal containing a monitored identifier within such time interval may be indicative of an undesired separation of the portable unit 103 from the monitored presence determining device 101 (e.g., that the possessor of the portable unit 103 has moved out of range of the presence determining device's transmitter 109) or that the person has been removed from the person support device without authorization of the possessor of the portable unit 103. The latter condition may indicate an abduction of the person being monitored. For example, as discussed above, the presence determining device 101 may be self-actuating in that the presence determining device 101 powers on and permits transmission of the status signal only when it detects that a person is present in a support device in which the presence determining device 101 is installed. If, at any point in time, the controller 107 of the presence determining device 101 determines that the person is no longer present in the person support device being monitored (e.g., by failing to sense at least one parameter indicative that the person is present within the person support device being monitored, such as by failing to detect appropriate pressure on weight or pressure sensors or by failing to detect that a seat belt buckle is buckled), the controller 107 ceases generation of the status signal. As a result, when the portable unit processor 115 fails to detect a status signal from a monitored presence determining device (i.e., a status signal containing a monitored identifier) within the predetermined time interval, the processor 115 instructs the alarm mechanism 121 to issue an alarm (e.g., the alarm indicating the most severe alarm condition) to the user. The portable unit processor 115 may be programmed to instruct the alarm mechanism to cease the alarm or alert in the event that the processor 115 again detects the monitored identifier at a later time (e.g., as would be the case where the possessor of the portable unit 103 moved back into the coverage range of the presence determining device's transmitter 109). Additionally, the portable unit processor 115 may be programmed to instruct the alarm mechanism to cease the alarm or alert in the event that the processor 115 detects user input (e.g., a pressing of the button 123), which may occur if the possessor of the portable unit 103 (e.g., a parent or caregiver) intentionally removed the person from the person support device without first de-activating the system 100.

FIG. 2 is a top view and block diagram of the system of FIG. 1 in accordance with an exemplary mat-type embodiment of the present invention. According to this embodiment, the presence determining device 101 includes a weight-sensitive mat 201 and at least one strap and buckle arrangement (two shown). The portable unit 103 is illustrated in this embodiment as a key fob. The mat 201 includes a housing 202, one or more weight or pressure sensors 203, a control module 204, and various signal wires or lines. The housing 202 encases the weight sensors 203, the control module 204, and the signal wires to protect them from damage during use. The housing 202 may also be aesthetically pleasing and include an outer surface that is comfortable to the touch. The housing 202 may optionally include cutouts 221, 222 to accommodate child seat harness straps when the mat 201 is intended for use in a child car seat. When use with a child car seat is intended, the housing 202 may further include an aperture 226 to accommodate passage of the seat's harness belt buckle through the housing 202 so that the harness buckle can be inserted into the corresponding harness belt clasp of the car seat. Still further, the housing 202 may optionally include a manually openable and closeable compartment for storing and retaining the control module 204 so that a user of the mat 201 can readily access the control module 204 as necessary to set the DIP switch 114 and/or change the battery.

In this embodiment, the control module 204 contains the controller 107, the transmitter 109, the power source 110, the antenna 111, the memory 113, and the optional DIP switch 114 or other functionally equivalent identifier-setting means for the presence determining device 101 (i.e., the control module 204 includes practically all of the non-sensor elements of the presence determining device 101). In the illustrated embodiment, several (e.g., nine) weight sensors 203 are distributed within the housing 202 about an area of the mat 201 on which a person (e.g., a child) is expected to sit or be placed. The weight sensors 203 may be implemented using pressure sensors that are commercially available from Recora Incorporated of Batavia, Ill. Each weight sensor 203 provides an output signal (e.g., voltage) when an amount of force sufficient to close the contact within the sensor 203 is applied. In other words, the weight sensors 203 sense a parameter (e.g., pressure or weight) that is indicative of whether a person is present on the mat 201 and in the person support device in which the mat 201 is installed. The outputs generated by the weight sensors 203 are supplied to the controller 107 in the control module 204. If the controller 107 detects one or more outputs from the weight sensors 203, the controller 107 determines that a person is present on the mat 201 and in the person support device in which the mat 201 is installed. In one embodiment in which the presence determining device 101 is self-activated, the controller 107 begins generating a status signal only after determining that a person is present in the person support device in which the presence determining device 101 is installed. Self-activation conserves battery power and extends battery life, as well as enables the portable unit processor 115 to accurately assess, during the training period, which presence determining devices 101 are to be monitored based on the identifiers contained in the received status signals.

As noted above, the exemplary presence determining device 101 illustrated in FIG. 2 also includes two optional strap and buckle arrangements. The first strap and buckle arrangement is a lap or chest belt and includes two straps 205, 206 and a buckle consisting of two buckle members 207, 208. The second strap and buckle arrangement is a retention belt and includes two straps 210, 211 and a buckle consisting of two buckle members 213, 214. In the depicted embodiment, each strap and buckle arrangement includes a magnetic sensor 207, 213 (e.g., a commercially available magnetic proximity sensor, such as Reed switch) positioned in or at least proximate to its respective female buckle member 207, 213. Each strap and buckle arrangement also includes a miniature magnet 218, 219 positioned in or at least proximate to its respective male buckle member 208, 214.

In operation, after a child sits or is placed upon the mat 201, straps 205 and 206 may be placed across the lap, waist, or chest of the child depending upon the child's orientation in the person supporting device in which the mat 201 is installed. Once the straps 205, 206 are properly situated, buckle members 207 and 208 are fastened together. Fastening of the buckle members 207, 208 secures the mat 201 to the child. Alternatively, where the presence determining device 101 is integrated into a car seat or other person support device, the straps 205, 206 and buckle members 207, 208 may be those elements that form the seat belt or other safety belt of the person support device itself. When the buckle members 207, 208 are fastened together, the magnet 218 in buckle member 208 is placed directly adjacent or at least proximate to magnetic sensor 215 causing magnetic sensor 215 to produce an output signal. The output signal is supplied to the controller 107 in the control module 204 (e.g., through a wire embedded in strap 205 and the housing 202). Thus, the lap belt buckle sensor 215 is adapted to detect whether or not the lap belt buckle is fastened. Upon receiving the signal from magnetic sensor 215, the controller 107 can detect the presence of the child in the car seat or other person support device in which the mat 201 is installed. Thus, the lap belt buckle sensor 215 provides yet another means by which the controller 107 can determine the presence of a person in the person support device in which the presence determining device 101 is installed. Where the presence determining device 101 includes a lap belt buckle sensor 215 as does the mat 201 of FIG. 2, the controller 107 can determine, based on the output of the buckle sensor 215, whether the lap belt buckle is fastened or unfastened and include in its status signal a status indicative of whether or not the buckle is fastened.

When the presence determining device 101 includes a retention belt strap and buckle arrangement, as does the exemplary mat 201 of FIG. 2, strap 211 of the retention belt arrangement may be looped around a seat belt, chair arm, stroller seat, or other portion or member of the person support device in which the presence determining device 101 is installed and then be secured at both ends to one of the buckle members (e.g., buckle member 214) of the retention belt arrangement. Once strap 211 is properly configured, buckle members 213 and 214 are fastened together. Fastening of the buckle members 213, 214 secures the mat 201 to the item around which strap 211 was looped. Alternatively, where a retention buckle is included with the mat 201, but the user does not desire to use it to secure the mat 201 to anything, the user may simply fasten the two buckle members 213, 214 together. When the buckle members 213, 214 are fastened together, the magnet 219 in buckle member 214 is placed directly adjacent or at least proximate to magnetic sensor 216 causing magnetic sensor 216 to produce an output signal. The output signal is supplied to the controller 107 in the control module 204 (e.g., through a wire embedded in strap 210 and the housing 202). Thus, the retention belt buckle sensor 216 is adapted to detect whether or not the retention belt buckle is fastened. Upon receiving the signal from magnetic sensor 216, the controller 107 can detect the presence of the child in the car seat or other person support device in which the mat 201 is installed. Thus, the retention belt buckle sensor provides yet another means by which the controller 107 can determine the presence of a person in the person support device in which the presence determining device 101 is installed. Where the presence determining device includes a retention belt buckle sensor 216 as does the mat 201 of FIG. 2, the controller 107 can determine, based on the output of the buckle sensor 216, whether the retention belt buckle is fastened or unfastened and include in its status signal a status indicative of whether or not the buckle is fastened. Upon comparing the exemplary mat 201 of FIG. 2 to the exemplary presence determining device 101 of FIG. 1 and considering the foregoing discussion, one skilled in the art will readily recognize that the sensors 105 referenced in the present determining device 101 of FIG. 1 are implemented by the weight sensors 203 and/or the buckle sensors 215, 216 in the exemplary embodiment illustrated of FIG. 2.

After the user has installed the mat 201 in the person support device (where the mat 201 is separate from the person support device) and secured the mat 201 to the person support device or something else with the retention belt (when included and used), as well as positioned the person on the mat 201 and fastened the lap belt (when included and used) across the lap, waist or chest of the person, the user may activate the system and commence the training period by pressing the button 123 on the portable unit 103 as described above with respect to FIG. 1. The portable unit processor 115 may provide visual (e.g., light-based), audible (e.g., beeps or synthesized or recorded voice), or tactile (e.g., vibratory) notification to the user that the portable unit 103 is powered on and the training period is in process. For example, the portable unit 103 may include a multi-colored (e.g., three colored) LED 224 as part of the alarm mechanism 121. Where the portable unit 103 includes such a multi-colored LED 224, the portable unit processor 115 may be programmed to change the LED color to a first color (e.g., yellow) to indicate that the portable unit 103 is on and to keep the LED 224 lit to the first color during the training period. In one embodiment, the training period lasts a predetermined period of time (e.g., approximately ten seconds). During the training period, the portable unit processor 115 receives status signals that are repeatedly (e.g., periodically) transmitted from presence determining devices 101 in whose coverage ranges the portable unit 103 is located (e.g., those presence determining devices 101 that are located within approximately sixteen (16) meters of the portable unit 103 and are active as a result of determining a presence of a person proximate each one). Based on the identifiers contained in the status signals received during the training period, the portable unit processor 103 determines how many presence determining devices 101 are to be monitored and stores the identifier list of the to-be-monitored presence determining devices 101 in memory 120.

Upon expiration of the training period, the portable unit processor 115 may notify the user that monitoring has begun. For example, the portable unit processor 115 may be programmed to blink the LED 224 a second color (e.g., green) and activate a tactile alert (e.g., buzzer) once for each presence determining device 101 being monitored by the portable unit 103. The portable unit processor 115 may be further programmed to provide a visual indication to the user to indicate that the portable unit 103 is on and monitoring the monitored presence determining devices 101. For example, the portable unit processor 115 may be programmed to slowly blink the LED between the second color (e.g., green) and no color (e.g., off) while the portable unit 103 is monitoring the presence determining devices 101.

If an alarm condition arises while the portable unit 103 is monitoring the presence determining devices 101, the portable unit processor 115 controls the alarm mechanism 121 to alert the user. There may be several different alarm conditions detectable by the portable unit processor 115 and corresponding alarms issued by the alarm mechanism 121 of the portable unit 103. Four exemplary alarms are listed in Table 1 below in order of severity, from most severe to least severe.

TABLE 1

| REASON | LED | BUZZER |
|---|---|---|
| Baby out of seat or seat | Blinking fast RED/OFF | Fast On/Off |
| out of range | | |
| Buckle undone (lap or | Blinking slowly RED/OFF | Slow On/Off |
| retention) | | |
| Battery low TX unit | Blinking slowly YELLOW/OFF | Slow On/Off |
| Battery low RX unit | Blinking slowly | None |
| | GREEN/YELLOW | |

As discussed above, the processor 115 of the portable unit 103 expects to receive a status signal from each monitored presence determining device 101 within predetermined time intervals (e.g., every 2-5, and preferably, 3 seconds). If the processor 115 fails to receive such a status signal, the processor 115 instructs the alarm mechanism 121 to issue the most severe alarm to the user (e.g., by sending a periodic drive signal to the LED driver circuitry causing the LED 224 to rapidly blink RED/OFF and sending a periodic drive signal to the tactile alert driver circuitry causing the tactile alert to buzz on and off rapidly). Upon receiving the alarm, the user can readily discern the cause of the alarm. For example, if the user is walking away from the person support device or devices in which the monitored presence determining device or devices 101 are installed, the user can quickly determine that he or she may have unintentionally left a child or other person in the person support device. On the other hand, if the user knows that he or she is well within the coverage range of the transmitter 109 of each monitored presence determining, the user can assume that child or other person has been removed or has removed him or herself without authorization.

Alternatively, the portable unit processor 115 may be programmed to more accurately discern whether a loss of status signal from a presence determining device 101 is due to movement of the portable unit 103 beyond the coverage area of the presence determining device's transmitter 109 or whether it is due to the person being removed from the person support device without authorization. For example, if the processor 115 detects a received status signal from a monitored presence determining device 101 indicating that the lap belt is fastened and, in the next sampling or measurement interval, detects a loss of status signal, the processor 115 could assume that the portable unit 103 has been moved beyond the coverage area of the presence determining device's transmitter 109 and cause the alert mechanism 121 to issue a unique alert (e.g., cause the LED 224 to illuminate solid RED and possibly cause the tactile alert to buzz continually). On the other hand, if the presence determining device 101 is transmitting status signals every 500 milliseconds or less and the processor 115 receives a status signal indicating unfastening of the lap belt within a predetermined number of measurement intervals before detecting a loss of status signal, the processor 115 could assume that the person has been removed from the person support device without authorization and cause the alert mechanism 121 to issue a unique alert (e.g., cause the LED 224 to toggle between solid RED and OFF very rapidly and possibly cause the tactile alert to buzz on and off rapidly). Those of ordinary skill in the art will appreciate that the portable unit processor 115 may be programmed to perform other analyses on the status signal contents and the timing between receipt of a status signal and loss thereof to provide more accurate or detailed alerts to the user.

If the processor timely receives status signals from all monitored presence determining devices 101 (e.g., mats 201), but one or more of the status signals indicates that either buckle has been unfastened, the processor 115 instructs the alarm mechanism 121 to issue a less severe alarm to the user (e.g., by sending a periodic drive signal to the LED driver circuitry causing the LED 224 to blink RED/OFF slowly and sending a periodic drive signal to the tactile alert driver circuitry causing the tactile alert to buzz on and off slowly). Upon receiving the alarm, the user can determine that the person (e.g., child) is still in the car seat or other person support device, but that one or more of the belts has been opened, and thus can investigate the cause of the alarm. While the alarm generated for an unfastened belt may be less severe than the alarm generated for loss of status signal, the alarm for an unfastened belt may still indicate a high level of severity due to the risk of an abduction and thereby signify the need for immediate or substantially immediate action by the system user (e.g., parent, guardian or caregiver).

Additionally, if the processor timely receives status signals from all monitored presence determining devices 101 (e.g., mats 201), but one or more of the status signals indicates that a battery level of a presence determining device 101 is low, the processor 115 instructs the alarm mechanism 121 to issue a low severity alarm to the user (e.g., by sending a periodic drive signal to the LED driver circuitry causing the LED 224 to blink YELLOW/OFF slowly and sending a periodic drive signal to the tactile alert driver circuitry causing the tactile alert to buzz on and off slowly). The alarm may also identify which presence determining device 101 has the low battery by, for example, repeatedly buzzing or blinking a number of times corresponding to the unit number as set by the user using the DIP switch 114. For example, if the DIP switch 114 permits four possible settings corresponding to four presence determining devices 101 and the battery level of the presence determining device 101 corresponding to DIP switch setting “2” is low, then the processor 115 may be programmed to blink or buzz two times on a periodic basis to inform the user that the presence determining device 101 having setting number “2” on the DIP switch 114 has a low battery. Upon receiving the alarm, the user can take appropriate action to change the low battery.

Further, if instead of receiving a low battery indication from one of the presence determining devices 101, the portable unit 103 determines that its own battery (not shown) is low, the processor 115 may be programmed to instruct the alarm mechanism 121 to issue a low severity alarm to the user (e.g., by sending a periodic drive signal to the LED driver circuitry causing the LED 224 to blink GREEN/OFF slowly). Upon receiving the alarm, the user can take appropriate action to change the low battery.

In one embodiment, the portable unit processor 115 causes all alarms or alerts to continue until the condition that caused the alarm has been rectified. The alarms can be temporarily silenced (e.g., for thirty seconds or another period of time) by pressing the button 123 on the portable unit 103. Those of ordinary skill in the art will readily recognize and appreciate that the alarms may be implemented in a variety of other formats and combinations, and that the exemplary alarms identified in Table 1 are merely illustrative in nature and are not intended to limit the scope of the appended claims in any way.

FIG. 3 is a cross-sectional view of a motor vehicle 301 incorporating a presence determining device 101 of the system 100 of FIG. 1 in accordance with an exemplary embodiment of the present invention. The motor vehicle may be a car, a truck, a van, a sport utility vehicle, or any other means for transporting two or more persons. The motor vehicle includes a cabin 303 containing two or more seats 305, 306 (two shown). A presence determining device 101 as described above with respect to FIG. 1 or 2 is installed in a person support device 308, such as a car seat or a booster seat, which is installed in seat 306. Alternatively, the presence determining device 101 may be installed directly on the vehicle seat 306 or be integrated into the vehicle seat 306 or the person support device 308.

In the case where the presence determining device 101 is a weight-sensitive mat 201 as described above with respect to FIG. 2, the mat 201 is placed or otherwise installed in each person support device 308 (e.g., a child seat or other child retaining device) or in each vehicle seat 306 to be monitored. A person (e.g., child) is then placed on top of each mat 201, which activates the controller 107 of each presence determining device 101 to begin transmitting status signals. If the presence determining device 101 also includes one or more strap and buckle arrangements, straps 205, 206 for one of the arrangements may be placed across the child's lap or chest (depending on the location of the strap and buckle arrangement and the child's orientation in the support device) and the buckle members 207, 208 fastened. In such a case, the controller 107 may be programmed to include a buckle status (e.g., open or closed) in the status signal as described above with respect to FIG. 2. If the presence determining device 101 includes a second strap and buckle arrangement, a strap 211 of this arrangement may be looped around something near the presence determining device 101, such as a seat belt or the handle of a shopping cart, and the buckle members 213, 214 fastened. In this case, the controller 107 may be programmed to include separate buckle statuses for the two buckles in the status signal. Alternatively, when the second strap and buckle arrangement is included and not used, the buckle members 213, 214 may be buckled together so that the controller 107 does not falsely indicate an open buckle within the status signal. Additionally, the battery level of the presence determining device's power source 110 may be optionally monitored by the controller 107 and a battery level status (e.g., normal or low) may be included in the status signal. In a further alternative embodiment in which the presence determining device 101 is implemented with only a strap and buckle arrangement (e.g., excluding weight sensors), the controller 107 may be programmed to commence generating status signals upon detecting the fastening of the buckle as indicated by an output of the buckle sensor 215.

In one embodiment, after a desired number of persons (e.g., children) have been positioned upon associated presence determining devices 101 located in person support devices 308 or on particular seats 306 within the vehicle 301, the system user (e.g., a parent or other caregiver) manually sets the unique identifier of each presence determining device 101 by configuring a DIP switch 114 of each presence determining device 101 such that none of the DIP switches 114 have the same setting. Alternatively, where each presence determining device 101 already has a unique identifier hard-coded into its memory 113 and does not include a DIP switch 114, manual setting of the identifier is not necessary. Additionally, even in an embodiment that requires manual DIP switch setting, such setting may need to be done only once at initial system setup—e.g., where the arrangement of presence determining devices 101 within the vehicle 301 or any other area is unlikely to change over time.

After the person or persons have been placed in their person support devices 306, 308 and the presence determining device or devices 101 have been configured, the system user powers the portable unit 103 on by, for example, pressing its button 123. Where the portable unit 103 includes a multi-color LED 224 as part of its alarm mechanism 121 as described above with respect to FIG. 2, the portable unit processor 115 may be programmed to change or set the LED color to a first color (e.g., yellow) to indicate that the portable unit 103 is on and to keep the LED lit to the first color during the training period. During the training period, the portable unit processor 115 receives status signals that are repeatedly (e.g., periodically) transmitted from the presence determining devices 101 in whose coverage ranges the portable unit 103 is located. Based on the identifiers contained in the status signals received during the training period, the portable unit processor 103 determines how many presence determining devices 101 are to be monitored and stores the identifier list of the to-be-monitored presence determining devices 101 in memory 120. Upon expiration of the training period, the portable unit processor 115 may notify the user that monitoring has begun and/or is ongoing (e.g., through a change of LED color and/or activation of a tactile alert, as well as optional use of slow blinking as described above with respect to FIG. 2).

If an alarm condition arises while the portable unit 103 is monitoring the presence determining devices 101, the portable unit processor 115 controls the alarm mechanism 121 to alert the user. Exemplary alerts provided by the portable unit 103 responsive to various alarm conditions are provided above in Table 1. When the user is ready to have the portable unit 103 stop monitoring the presence determining devices 101 and to take the persons out of them, the user can instruct the system 100 to cease the monitoring process by, for example, pressing and holding the button 123 on the portable unit 103 for a predetermined period of time (e.g., three seconds). The portable unit processor 115 may be programmed to provide the user a visual indication that the portable unit is turning off. For example, upon detecting that the button 123 has been pressed and held for more than one second, the portable unit processor 115 may change the color of the LED to the first color (e.g., yellow) or any other color and maintain the color until the portable unit turns off, at which point the LED would go out. Those of ordinary skill in the art will readily recognize that various alternative combinations of visual, audible, and/or tactile alerts may be used, depending upon system implementation, to inform the user that the portable unit 103 is engaged in the training mode, that the portable unit 103 is monitoring the presence determining devices 101, that an alarm condition has occurred, and that the system 100 is shutting off. All such alternatives are encompassed by the spirit and scope of the appended claims.

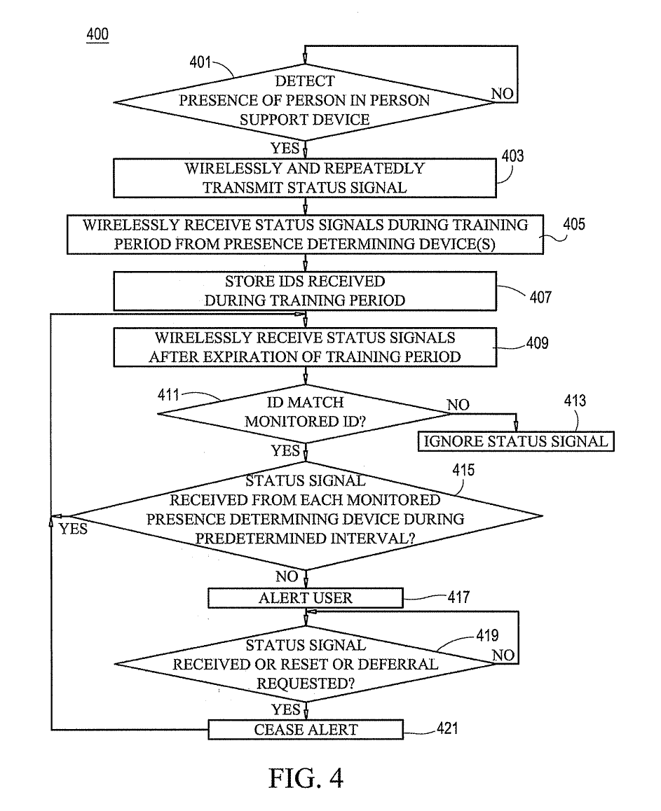

FIG. 4 is a flow diagram 400 of a method for wirelessly monitoring a presence or absence of one or more persons in or from associated person support devices in accordance with an exemplary embodiment of the present invention. The logic flow begins when a presence determining device detects (401) whether a person is present in a person support device in which the presence determining device is installed. If the presence determining device detects the presence of a person, the presence determining device wirelessly and repeatedly (e.g., every three hundred (300) milliseconds) transmits (403) a status signal containing an identifier for the presence determining device and, optionally, a variety of status information, such as a battery level status and/or the fastened or unfastened status of lap belt or retention belt buckle (when included as part of the present determining device). If the presence determining device does not detect the presence of a person in the person supporting device in which it is installed, the presence determining device continues monitoring for the presence of a person, but does not transmit a status signal in order to conserve power and extend battery life. As an alternative procedure for conserving battery power, the presence determining device may be programmed to transmit a status signal on an occasional basis (e.g., every two minutes or on a progressive time scale) indicating that the presence of a person has not been detected, thereby providing positive notification that a person is not present.

After being powered on, the portable unit wirelessly receives (405) status signals during a training period from presence determining devices within a reception coverage area of the portable unit. In one embodiment, the training period is approximately ten (10) seconds long; however, alternative lengths of time may be used. The training period allows the portable unit to receive status signals from the presence determining devices which will be monitored by the portable unit upon expiration of the training period. Upon receiving status signals during the training period, the portable unit stores (407), in memory, the identifiers contained in the status signals. The stored identifiers become the identifiers monitored by the portable unit upon expiration of the training period. As described above, each presence determining device has a respective identifier, which corresponds to a person support device (and, accordingly, a person positioned therein or thereon) in which the presence determining device is installed.

After expiration of the training period, the portable unit wirelessly receives (409) status signals from various presence determining devices. The portable unit compares (411) the identifier in each received post-training status signal to the stored list of monitored identifiers. If the identifier in a received post-training status signal does not match one of the monitored identifiers, the portable unit ignores (413) the status signal because the status signal is likely from a presence determining device in another system (e.g., in a car parked next to the car in which the monitored presence determining devices are installed). On the other hand, if the identifier in a received post-training status signal matches one of the monitored identifiers, the portable unit determines (415) whether it has received post-training status signals containing all the monitored identifiers during a predetermined time interval. In other words, upon completion of the training period, the portable unit expects to receive, within repeating predetermined time intervals, at least one post-training status signal from each monitored presence determining device containing the monitored identifier of the respective monitored presence determining device. In one embodiment, the repeating time interval is in the range of two (2) to five (5) seconds (preferably three (3) seconds), although other measurement intervals may be used. Thus, if each monitored presence determining device is issuing status signals every three hundred (300) milliseconds and the portable unit is located within range of the monitored presence determining devices, the portable unit will likely receive multiple status signals from each monitored presence determining device during each measurement time interval.

If the portable unit has received post-training status signals from each of the monitored presence determining devices during a particular measurement interval, the logic flow returns to block 409 for analysis of received status signals during the next measurement interval. If, on the other hand, the portable unit has not received a status signal from each monitored presence determining device during a particular measurement interval, the portable unit alerts (417) the user of the portable unit. As detailed above with respect to FIGS. 1-3, the alert or alarm may be visual, audible, tactile, or a combination thereof. After alerting the user, the portable unit determines (419) whether it has received a missing status signal or whether the user has requested a reset of the system or deferral of the alarm (e.g., by pressing a button on the portable unit). For example, the portable unit may have issued the alert because it was missing a status signal from at least one presence determining device and then receives the missing status signal(s) during the alerting phase of operation (which may be indicative that the user is returning to retrieve the person from the person supporting device). Alternatively, the alarm may have served its purpose of alerting the user and the user may wish to reset the system or at least turn off the alarm temporarily so that he or she may attend to the alarm condition. If the missing status signal is received or a system reset or alarm deferral request is detected, the portable unit ceases (421), at least temporarily, alerting the user. In other words, by receiving the missing status signal or receiving an affirmative response from the user, the portable unit effectively acknowledges that the user is taking action to remedy the situation that resulted in the alarm. The logic flow then returns to block 409 for analysis of received status signals during the next measurement interval.

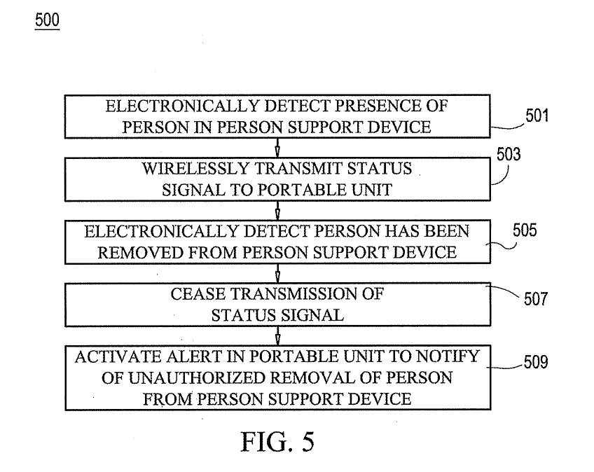

FIG. 5 is a flow diagram 500 of a method for automatically detecting unauthorized removal of a person from a person support device in accordance with an alternative embodiment of the present invention. The logic flow begins when a presence determining device electronically detects (501) the presence of a person in a person support device in which the presence determining device is installed. For example, as detailed above, the presence determining device may be a weight-sensitive mat or such a mat in combination with one or more strap and buckle arrangements. Alternatively, the presence determining device may be any other device that senses or detects the presence of a person in contact with it or proximate to it. In one embodiment, a controller, processor or equivalent device in the presence determining device detects pressure on a weight-sensitive mat, fastening of a buckle, or other parameters indicative of the presence of a person in contact with or proximate to the presence determining device. Because the presence determining device is installed in a person support device when the presence determining device detects the presence of a person in contact with it or in proximity to it, the presence determining device necessarily also determines whether the person is in the person support device in which the presence determining device is installed.

Responsive to detecting the presence of a person in a person support device, the presence determining device wirelessly transmits (503) a status signal to a portable unit possessed by a caregiver of the person in the person support device. The status signal includes an identifier of the presence determining device that transmitted the signal. In one embodiment, the status signal is repeatedly transmitted (e.g., periodically or aperiodically) by the presence determining device to allow the portable unit to receive the status signal when the portable unit is located within the coverage area of the presence determining device's transmitter. Once monitoring of the presence determining device has begun, failure of the portable unit to receive a status signal from the monitored presence determining device (e.g., failure of the portable unit to receive a status signal containing an identifier corresponding to an identifier being monitored by the portable unit) within a predetermined time interval (e.g., every 2-5 seconds) results in a determination that the person has been removed from the person support device or that the person support device has been moved outside the coverage range of the presence determining device's transmitter without authority of the person's caregiver.

In the event that the person is subsequently removed from the person support device while the person monitoring system is active, the presence determining device electronically detects (505) that the person has been removed from the person support device (e.g., by detecting a loss of pressure on a weight-sensitive mat or the unbuckling of a seat buckle) and ceases (507) transmission of the presence determining device's status signal. In other words, when the person monitoring system is active, the presence determining device transmits a status signal so long as it detects the presence of a person in the person support device being monitored. Once the person leaves or is removed from the monitored person support device, the presence determining device ceases transmission of the signal, which notifies the portable unit that an unauthorized removal of the person, the person support device (likely with the person in it), or the presence determining device (again, likely with the person in it) has occurred.

Responsive to detecting a cessation of transmission of the status signal from the presence determining device without a reset of the system, the portable unit activates (509) an alert mechanism to notify the user of the unauthorized removal (e.g., abduction) of the person from the person support device. As detailed above, the alert may be audible, visual, tactile, or a combination thereof. If the portable unit has multiple alerts or alarms based on severity levels of particular conditions as illustrated above in Table 1, the portable unit preferably uses an alert associated with a highest severity level to notify the user of the potential abduction of the person.

The present invention encompasses a method and system for wirelessly monitoring the presence or absence of a person, such as a child, from a person support device, such as a car seat, playpen, stroller, or bed. The system of the present invention may be provided in the form of a kit (e.g., a portable unit in combination with one or more presence determining devices) for use with various person support devices or may include one or more person support devices, such as when the presence determining devices are integrated into the person support devices. Alternatively, the system may form part of a motor vehicle that includes seats in or on which one or more presence determining devices are installed. With this invention, multiple persons (e.g., children) can be individually monitored in car seats, strollers, and other person support devices with a single portable unit to mitigate potential harm to the persons as a result of distraction of a caregiver. Prior art car seat monitoring devices do not contemplate use of multiple presence determining devices with a single portable unit. Additionally, the present invention facilitates monitoring for abduction of a monitored person by, for example, providing for the automatic cessation of status signal transmission when a person has been removed from a person support device. Such cessation of status signal transmission notifies the portable unit of an alarm condition and enables the portable unit to promptly notify the user of a possible abduction. Prior art car seat monitoring systems do not account for abduction and instead focus primarily on monitoring for whether a parent or other caregiver may have unintentionally left a child or object in or at a given location, such as a car.

It will be appreciated that embodiments of the presence determining device 101 and the portable unit 103 described herein may be comprised of one or more conventional processors and unique stored program instructions that control the processor(s) to implement, in conjunction with certain non-processor circuits, some, most, or all of the functions of the presence determining device 101 and the portable unit 103 and their operational methods as described herein. The non-processor circuits may include, but are not limited to, the antennas 111, 119, the transmitter 109, the receiver 117, the sensors 105, the alarm mechanism 121, the DIP switch 114, the memory elements 113, 120, the button 123, and the power source 110 described above, as well as filters, signal drivers, clock circuits, power control circuits, user input devices, and various other non-processor circuits. As such, the functions of these non-processor circuits may be interpreted as steps of a method to facilitate monitoring the presence or absence of one or more persons in or from associated person support devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been generally described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions or programs and integrated circuits without undue experimentation.

In the foregoing specification, specific embodiments of the present invention have been described. However, one of ordinary skill in the art will appreciate that various modifications and changes can be made without departing from the scope of the present invention as set forth in the claims below. For example, each presence determining device may include a receiver or transceiver and the portable unit may include a transmitter or transceiver, and the presence determining devices and the portable unit may be programmed to implement a reliable protocol in which the portable unit transmits acknowledgements to each presence determining device to confirm receipt of a status signal. In such a case, the potable unit may also transmit a monitored device confirmation to each presence determining device which the portable unit will be monitoring after expiration of the training period to inform the presence determining devices of their monitored status. In this embodiment, if a monitored presence determining device does not receive an acknowledgement in response to a status signal, the presence determining device may take predetermined action (e.g., activate an audible alarm in included in or coupled to the presence determining device). Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

What is claimed is:

1. A person monitoring system for use with at least one person support device, the person monitoring system comprising:
at least one presence determining device, each presence determining device being adapted for installation in a corresponding person support device and including:
at least one sensor operable to sense at least one parameter indicative of whether a person is present within a person support device in which the presence determining device is installed;
a controller coupled to the at least one sensor and operable to generate a status signal responsive to the at least one sensor sensing at least one parameter indicative that a person is present within a person support device in which the presence determining device is installed, the status signal including at least an identifier associated with the presence determining device; and
a transmitter operably coupled to the controller and operable to wirelessly and repeatedly transmit the status signal; and
a portable unit configured to be carried by a user and including:
a receiver operable to receive status signals transmitted by the at least one presence determining device when the receiver is within a predetermined distance of the at least one presence determining device and the portable unit is powered on;
a processor operably coupled to the receiver, the processor operable to determine an identifier included in each status signal received during a training period commencing after the portable unit has been powered on to produce at least one monitored identifier and to only process status signals that include the at least one monitored identifier after expiration of the training period; and
an alarm mechanism operably coupled to the processor, the alarm mechanism operable to notify the user of at least one alarm condition responsive to commands from the processor;
wherein the processor is further operable, while the portable unit is powered on, to determine an alarm condition responsive to failure of the receiver of the portable unit to receive a status signal that includes the at least one monitored identifier within predetermined time intervals commencing after expiration of the training period and to instruct the alarm mechanism to issue an alarm to the user responsive to determination of the alarm condition.

2. The person monitoring system of claim 1, wherein the at least one person support device is at least one child support device.

3. The person monitoring system of claim 2, wherein the at least one child support device is at least one of a car seat, a baby carrier, a stroller, a crib, a playpen, and a bed.

4. The person monitoring system of claim 1, wherein the alarm condition is indicative of an undesired separation of the portable unit from a presence determining device corresponding to a monitored identifier.

5. The person monitoring system of claim 1, wherein the controller is further operable to cease generation of the status signal responsive to the at least one sensor failing to sense at least one parameter indicative that a person is present within the person support device in which the presence determining device is installed and wherein the alarm condition is indicative of an undesired removal of a person from a person support device in which a presence determining device corresponding to a monitored identifier is installed.

6. The person monitoring system of claim 1, wherein each presence determining device includes a weight-sensitive mat and wherein the at least one sensor is positioned in the mat to detect a presence of a person in the person support device in which the presence determining device is installed based on weight-induced pressure on the at least one sensor.

7. The person monitoring system of claim 6, wherein each presence determining device further includes at least one strap and buckle arrangement operable, when fastened, to assist in securing a person to at least one of the presence determining device and the person support device in which the presence determining device is installed, wherein the at least one sensor is further positioned proximate a buckle of the strap and buckle arrangement and adapted to detect whether the buckle is fastened, and wherein the controller is further operable to generate a second status signal indicative of whether the buckle is unfastened.

8. The person monitoring system of claim 6, wherein each presence determining device further includes at least one strap and buckle arrangement operable to assist in securing a person to at least one of the presence determining device and the person support device in which the presence determining device is installed, wherein a buckle sensor of the at least one sensor is positioned proximate a buckle of the strap and buckle arrangement and adapted to detect whether the buckle becomes unfastened, wherein the controller is further operable to generate a second status signal responsive to the buckle sensor sensing that the buckle is unfastened, wherein the transmitter is further operable to wirelessly transmit the second status signal, and wherein the processor of the portable unit is further operable to instruct the alarm mechanism to issue a second alarm responsive to processing the second status signal after expiration of the training period provided that the second status signal includes the at least one monitored identifier.

9. The person monitoring system of claim 1, wherein each presence determining device includes at least one strap and buckle arrangement operable to assist in securing a person to at least one of the presence determining device and the person support device in which the presence determining device is installed, wherein the at least one sensor is positioned proximate a buckle of the strap and buckle arrangement to detect a presence of a person based on whether the buckle is fastened.

10. The person monitoring system of claim 1, wherein the predetermined time intervals are intervals in the range of two to five seconds.

11. The person monitoring system of claim 1, further comprising the at least one person support device.

12. The person monitoring system of claim 1, wherein the presence determining device further includes a battery coupled to at least the controller and the transmitter, wherein the controller is further operable to generate a second status signal indicative of a battery level status of the battery when an output level of the battery falls below a predetermined threshold.

13. The person monitoring system of claim 1, wherein the presence determining device further includes means, coupled to the controller, for at least partially manually setting the identifier associated with the presence determining device.

14. The person monitoring system of claim 1, wherein the means for at least partially manually setting the identifier associated with the presence determining device comprises a dual inline package (DIP) switch.

15. The person monitoring system of claim 1, wherein each presence determining device is operable to periodically transmit the status signal.

16. A person monitoring system for use with a plurality of person support devices, the person monitoring system comprising:
a plurality of presence determining devices, each presence determining device being adapted for installation in a corresponding person support device and including:
at least one sensor operable to sense at least one parameter indicative of whether a person is present within a person support device in which the presence determining device is installed;
a controller coupled to the at least one sensor and operable to generate a status signal responsive to the at least one sensor sensing at least one parameter indicative that a person is present within a person support device in which the presence determining device is installed, the status signal including at least an identifier associated with the presence determining device; and
a transmitter operably coupled to the controller and operable to wirelessly and repeatedly transmit the status signal; and
a portable unit configured to be carried by a user and including:
a receiver operable to receive status signals transmitted by the plurality of presence determining devices when the receiver is within a predetermined distance of the plurality of presence determining devices and the portable unit is powered on;
a processor operably coupled to the receiver, the processor operable to determine an identifier included in each status signal received during a training period commencing after the portable unit has been powered on to produce a plurality of monitored identifiers and to only process status signals that include at least one of the plurality of monitored identifiers after expiration of the training period; and
an alarm mechanism operably coupled to the processor, the alarm mechanism operable to notify the user of at least one alarm condition responsive to commands from the processor;
wherein the processor is further operable, while the portable unit is powered on, to determine an alarm condition responsive to failure of the receiver of the portable unit to receive, for each monitored identifier of the plurality of monitored identifiers, a status signal that includes the monitored identifier within predetermined time intervals commencing after expiration of the training period and to instruct the alarm mechanism to issue an alarm to the user responsive to determination of the alarm condition.

17. The person monitoring system of claim 16, further comprising the plurality of person support devices.

18. A motor vehicle comprising:
a cabin that includes a plurality of seats; and
a person monitoring system that includes:
at least one presence determining device installed in at least one of the plurality of seats, the at least one presence determining device including:
at least one sensor operable to sense at least one parameter indicative of whether a person is present within a seat in which the presence determining device is installed;
a controller coupled to the at least one sensor and operable to generate a status signal responsive to the at least one sensor sensing at least one parameter indicative that a person is present within the seat in which the presence determining device is installed, the status signal including at least an identifier associated with the presence determining device; and
a transmitter operably coupled to the controller and operable to wirelessly and repeatedly transmit the status signal; and
a portable unit configured to be carried by a user and including:
a receiver operable to receive status signals transmitted by the at least one presence determining device when the receiver is within a predetermined distance of the at least one presence determining device and the portable unit is powered on;
a processor operably coupled to the receiver, the processor operable to determine an identifier included in each status signal received during a training period commencing after the portable unit has been powered on to produce at least one monitored identifier and to only process status signals that include the at least one monitored identifier after expiration of the training period; and
an alarm mechanism operably coupled to the processor, the alarm mechanism operable to notify the user of at least one alarm condition responsive to commands from the processor;
wherein the processor is further operable, while the portable unit is powered on, to determine an alarm condition responsive to failure of the receiver of the portable unit to receive a status signal that includes the at least one monitored identifier within predetermined time intervals commencing after expiration of the training period and to instruct the alarm mechanism to issue an alarm to the user responsive to determination of the alarm condition.

19. A portable unit for use by a user of a person monitoring system that includes at least one presence determining device installed in at least one person support device, the portable unit comprising:
a receiver operable to receive status signals transmitted by the at least one presence determining device when the receiver is within a predetermined distance of the at least one presence determining device and the portable unit is powered on;
a processor operably coupled to the receiver, the processor operable to determine an identifier included in each status signal received during a training period commencing after the portable unit has been powered on to produce at least one monitored identifier and to only process status signals that include the at least one monitored identifier after expiration of the training period; and
an alarm mechanism operably coupled to the processor, the alarm mechanism operable to notify the user of at least one alarm condition responsive to commands from the processor;
wherein the processor is further operable, while the portable unit is powered on, to determine an alarm condition responsive to failure of the receiver of the portable unit to receive a status signal that includes the at least one monitored identifier within predetermined time intervals commencing after expiration of the training period and to instruct the alarm mechanism to issue an alarm to the user responsive to determination of the alarm condition

20. The portable unit of claim 19, wherein the portable unit is a key fob.

21. A system for detecting unauthorized removal of a child from a child retaining device, the system comprising:
a presence determining device adapted for installation in a child retaining device and including:
at least one sensor operable to sense whether a child is present within the child retaining device;
a controller coupled to the at least one sensor, the controller being operable to generate a status signal responsive to the at least one sensor sensing at that a child is present within the child retaining device and being further operable to cease generation of the status signal responsive to the at least one sensor failing to sense that a child is present within the child retaining device; and
a transmitter operably coupled to the controller and operable to wirelessly and repeatedly transmit the status signal; and
a portable unit configured to be carried by a user and including:
a receiver operable to receive status signals transmitted by the presence determining device when the receiver is within a predetermined distance of the presence determining device and the portable unit is powered on;
a processor operably coupled to the receiver, the processor operable to:
process a status signal received from the presence determining device during a first time period commencing after the portable unit has been powered on and the child has been placed in the child retaining device,
determine that the receiver has failed to receive a status signal from the presence determining device during a second period of time occurring after the first period of time and while the portable unit is within the predetermined distance of the presence determining device and still powered on without having been powered off, and
generate an alarm signal responsive to determining that the receiver failed to receive a status signal from the presence determining device during the second period of time; and
an alarm mechanism operably coupled to the processor, the alarm mechanism operable to notify the user of an undesired removal of the child from the child retaining device responsive to the alarm signal.

22. The system of claim 21, wherein the child retaining device is at least one of a car seat, a booster seat, a baby carrier, a stroller, a crib, a playpen, and a bed.

23. A method for wirelessly monitoring a presence or absence of a plurality of persons, wherein each person is initially positioned in a respective person support device and each person support device includes a presence determining device operable to detect a presence of a person in the person support device, the method comprising:
wirelessly receiving, at a portable unit, status signals during a training period from a plurality of presence determining devices, each status signal including a respective identifier corresponding to a presence determining device that transmitted the status signal;
storing, at the portable unit, identifiers included in status signals received during the training period to produce monitored identifiers;
wirelessly receiving, at the portable unit, status signals from at least some of the plurality of presence determining devices after expiration of the training period to produce post-training status signals;
determining, at the portable unit, whether each monitored identifier is included in at least one respective post-training status signal received during a predetermined time interval; and
alerting a user of the portable unit in the event that at least one monitored identifier is not included in at least one respective post-training status signal received during the predetermined time interval.

24. The method of claim 23, further comprising:
ceasing alerting the user of the portable unit in the event that the at least one monitored identifier is included in at least one respective post-training status signal received after the predetermined time interval.

25. The method of claim 23, further comprising:
detecting, at each presence determining device of the plurality of presence determining devices, whether a person is present in a person support device in which the presence determining device is installed; and
responsive to detecting the presence of a person in the person support device, wirelessly and repeatedly transmitting, by the presence determining device, a status signal including an identifier of the presence determining device.

26. The method of claim 23, wherein the step of alerting a user of the portable unit comprises at least one of audibly, visually, and tactilely alerting the user of the portable unit.

27. The method of claim 23, wherein the predetermined time interval is an interval in the range of two to five seconds.

28. A method for automatically detecting unauthorized removal of a person from a person support device, the person being under care of a caregiver, the method comprising:
electronically detecting a presence of the person in the person support device;
subsequent to detecting the presence of the person in the person support device, wirelessly transmitting a status signal to a portable unit in possession of the caregiver, the status signal indicating that the person is present in the person support device;
subsequent to wirelessly transmitting the status signal, electronically detecting that the person has been removed from the person support device;
responsive to detecting removal of the person from the person support device, ceasing wireless transmission of the status signal; and
responsive to detecting cessation of transmission of the status signal, activating an alert in the portable device to notify the caregiver of the removal of the person from the person support device.
